(19) United States
(12) Patent Application Publication
(10) Pub. No.: US 2005/0068589 A1
(43) Pub. Date: Mar. 31, 2005

(54) Pictures with embedded data

(75) Inventors: George Inness, Cary, NC (US); Shmuel Ur, D.N. Misgav (IL)

Correspondence Address: Stephen C. Kaufman;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/673,530

(22) Filed: Sep. 29, 2003

(51) Int. Cl. G06K 15/02; H04N 1/40; H04N 1/405; G10L 13/08; G10L 15/26

(52) U.S. Cl. 358/3.28; 704/235; 704/260; 358/3.12

(57) ABSTRACT

A picture, consisting of a hard-copy medium and pigment, the pigment being imprinted on the hard-copy medium so as to define an image incorporating markings that are substantially imperceptible to an unaided eye of a human viewer. The markings encode audio data associated with the image.

### FIELD OF THE INVENTION

The present invention relates generally to methods and systems for representing multimedia data, and specifically to combining audio data with a representation of graphical data.

### BACKGROUND OF THE INVENTION

Steganography is a process that hides data, typically encrypted data, within other data, and is used, for example, to secrete a data file within an image file. The final composite file may be printed on paper, or projected onto a screen, producing no noticeable difference from the original image file. For example, ClickOK Ltd. of London, United Kingdom, produce “Palmtree 3.3” software, which enables a data file that is approximately 10% of the size of an image file to be hidden within the image file.

Rosen et al. describe a method for concealing a hidden image within a different hardcopy image in “Concealogram: An Image Within an Image,” Proceedings of SPIE 4789 (2002), pages 44-54, whose disclosure is incorporated herein by reference. The method described in this article is based on the use of halftone coding to represent continuous-tone images by binary values, wherein the tone levels of the original image are translated into the areas of binary dots making up the halftone image. In conventional halftone coding, the positions of the dots inside their cells do not represent any information. Rosen et al. propose a method of encoding visual information in the halftone image by means of the locations of the dots inside their cells, allowing one image to be hidden within another. The printed image can then be read by a conventional optical scanner and processed by computer or optical correlator to access the hidden image.

In a related process, a watermark may be digitally introduced into a document, typically for the purpose of identifying the document in a relatively unobtrusive manner. Introduction and detection of an imperceptible watermark into a document are also known in the art. For example, U.S. Pat. No. 6,263,086 to Wang, whose disclosure is incorporated herein by reference, describes a process for detection and retrieval of embedded invisible digital watermarks from halftone images. The process introduces a watermark, invisible to the human eye, into the image. The existence and integrity of the watermark and of the image may be verified by scanning the image. As another example, U.S. Pat. No. 5,568,550 to Ur, whose disclosure is incorporated herein by reference, describes a process for identifying software used to produce a document. The process introduces an invisible signature into the document, the signature being readable by a scanner.

Digital cameras comprising a microphone are known in the art. Such cameras are capable of generating a video file of still or moving graphical images and an audio file of sound. For example, the EX-M1 camera, produced by Casio Computer Co. Ltd., of Tokyo, Japan, is able to produce an “Audio Snapshot” comprising up to 30 s of audio and an associated still or moving image. Camcorders perform substantially the same task over greater time periods. In both products, the video and audio files are separate and may be used either together or separately.

### SUMMARY OF THE INVENTION

In preferred embodiments of the present invention, audio data associated with an original image is embedded within a composite image, herein also termed a picture. The audio data are contained in the picture in the form of markings that are substantially imperceptible to the eye of a viewer. When the picture is scanned by a computerized scanner, however, the audio data can be identified and recovered from the scanned markings and can thus be played back audibly. Producing a picture having substantially imperceptible markings that may be scanned to recover the audio data is a convenient way of associating and transferring the audio data with the original image.

In the context of the present patent application and in the claims, the term “substantially imperceptible” in reference to markings added to a printed image means that the markings do not affect the visual information content of the a printed image as seen by the unaided eye of a human viewer. It is possible, however, that the markings may be seen given sufficient magnification of the image or using other means of detail enhancement.

The composite image may be produced from a composite data file, which is generated by a digital camera having a microphone for recording the audio data associated with the original image. The composite file may be used to generate the picture as a hard copy, such as is suitable for a photograph album, or as a transparency that is projected onto a screen. Alternatively, the composite image may be produced by a computer, based upon separate image and audio input files, or by a printer that is specially equipped to receive and process audio input together with image input.

There is therefore provided, according to a preferred embodiment of the present invention, a picture, consisting of:
a hard-copy medium; and
pigment, imprinted on the hard-copy medium so as to define an image incorporating markings that are substantially imperceptible to an unaided eye of a human viewer and that encode audio data associated with the image.

Preferably, the pigment is imprinted on the hard-copy medium so as to define dots of varying sizes within respective cells, and the audio data are encoded in the picture by varying respective positions of the dots within the respective cells.

There is further provided, according to a preferred embodiment of the present invention, a method for encoding information, including:
capturing an image of a subject so as to generate image data;
receiving an audio input associated with the subject so as to generate audio data; and
printing a picture of the subject responsively to the image data, while encoding the audio data using markings in the printed picture that are substantially imperceptible to an unaided eye of a human viewer.

Preferably, capturing the image includes photographing the image using an electronic imaging camera, and receiving the audio input includes recording the audio input using a microphone coupled to the camera.

Further preferably, printing the picture includes printing a halftone picture consisting of dots of varying sizes within respective cells, and encoding the audio data includes varying respective positions of the dots within the cells responsively to the audio data.

The method preferably includes detecting and decoding the markings in the printed picture, and generating an audio output responsively to the decoded markings. Most preferably, the audio input consists of speech, and receiving the audio input includes converting the speech to at least one of text and prosody of the speech, and encoding the audio data comprises encoding the at least one of the text and the prosody.

There is further provided, according to a preferred embodiment of the present invention, a method for recovering information, including:
scanning a picture consisting of an image and incorporating in the image markings that are substantially imperceptible to an unaided eye of a human viewer and that encode audio data associated with the image;
detecting and decoding the markings in the scanned picture; and
generating an audio output responsively to the decoded markings.

There is further provided, according to a preferred embodiment of the present invention, apparatus for encoding information, including:
an image capture device, which is arranged to capture an image of a subject so as to generate image data;
a processor, which is coupled to receive audio data associated with the subject, and which is arranged to generate a composite image of the subject including the image data, while encoding the audio data in the composite image using markings that are substantially imperceptible to an unaided eye of a human viewer; and
a printer, which is arranged to print a picture of the subject including the encoded audio data responsively to the composite image.

Preferably the image capture device includes an electronic imaging camera, which further includes a microphone for capturing the audio data.

Further preferably, the picture includes a halftone picture consisting of dots of varying sizes within respective cells, and the processor is arranged to vary respective positions of the dots within the cells so as to encode the audio data.

The apparatus preferably also includes a scanner, which is arranged to detect the markings in the printed picture, so as to permit an audio output to be generated responsively to the markings.

Preferably, the audio data includes speech, and the apparatus includes a speech-to-text converter that converts the speech to at least one of text and prosody of the speech, and encoding the audio data consists of encoding the at least one of the text and the prosody.

There is further provided, according to a preferred embodiment of the present invention, apparatus for recovering information, including:
a scanner, which is arranged to scan a picture including an image incorporating markings that are substantially imperceptible to an unaided eye of a human viewer and that encode audio data associated with the image;
a processor, which is arranged to detect and decode the markings in the scanned picture so as to recover the audio data from the picture; and
an audio speaker, which is coupled to the processor so as to play the recovered audio data.

There is further provided, according to a preferred embodiment of the present invention, a computer software product, consisting of a computer-readable medium in which program instructions are stored, which instructions, when read by a programmable processor, cause the processor to receive image data representative of an image of a subject, and to receive audio data associated with the subject, and to generate a picture of the subject including the image data, while encoding the audio data in the picture using markings that are substantially imperceptible to an unaided eye of a human viewer.

The picture preferably includes a halftone picture consisting of dots of varying sizes within respective cells, and the instructions cause the processor to vary respective positions of the dots within the cells so as to encode the audio data. Preferably, the instructions further cause the processor to detect the markings in the printed picture, so as to recover the audio data from the markings.

There is further provided, according to a preferred embodiment of the present invention, a computer software product, consisting of a computer-readable medium in which program instructions are stored, which instructions, when read by a programmable processor, cause the processor to receive input data from a scanned image of a picture that incorporates markings that are substantially imperceptible to an unaided eye of a human viewer and that encode audio data associated with the image, and to detect and decode the markings in the scanned image so as to recover the audio data from the picture.

The present invention will be more fully understood from the following detailed description of the preferred embodiments thereof, taken together with the drawings, a brief description of which follows.

### BRIEF DESCRIPTION OF THE DRAWINGS

FIG. 1 is a schematic illustration of apparatus used for producing an image embedded with audio data, according to a preferred embodiment of the present invention;

FIG. 2 is a flowchart showing steps of a process used to produce the image embedded with the audio data of FIG. 1, according to a preferred embodiment of the present invention;

FIG. 3 is a schematic, detail view of an image with embedded audio data, according to a preferred embodiment of the present invention;

FIG. 4 is a schematic illustration of a system for recovering audio embedded in a hard copy image, according to a preferred embodiment of the present invention; and

FIG. 5 is a flowchart illustrating steps of a process for recovering audio data from a hard copy image, according to a preferred embodiment of the present invention.

### DETAILED DESCRIPTION OF PREFERRED EMBODIMENTS

Reference is now made to FIG. 1, which is a schematic illustration of apparatus used for producing an image embedded with audio data, according to a preferred embodiment of the present invention. A camera 12 is configured to generate an image file corresponding to a still image of a subject 16. Such a camera may be a digital camera, a video camera, or any other suitable image-capture device that is able to generate an image file of subject 16. A microphone 14 is preferably coupled to the camera circuits in order to generate an audio file from sound received by the microphone. These functions of camera 12 are known in the art. Subject 16 is shown, by way of example, to be a person, but it will be appreciated that the subject may comprise substantially any scene or object that camera 12 may image.

A user 22 of camera 12 and microphone 14 operates the camera to form an original image of subject 16. In the present example, at approximately the same time as the original image is formed, the user gives an audio description 18 of subject 16 by talking into microphone 14 so as to generate an audio file which is associated with the subject. Alternatively, the audio file may be generated by other sources. For example, subject 16 may speak, sing, or transmit other sounds into the microphone. As a further example, if subject 16 comprises an inanimate object such as a bell or group of bells, or a non-human animate object such as a bird, sound from the object, or sound otherwise associated with the object, may be at least partially used to generate the audio file. Further alternatively, the audio associated with the subject need not necessarily be generated by a microphone attached to camera 12, and need not be input at the time the image of subject 16 is formed. Rather, the audio may comprise pre-recorded sound, or sound which is recorded at some time after the image of the subject is formed. Typically, the audio is of approximately 30 sec duration, although the duration may be longer or shorter than this period. The present invention may be used to associate substantially any sort of audio data with an image.

In order to produce a hard copy picture 40 of the image of subject 16, camera 12 typically transfers the image and audio data to a computer 20. The computer drives a printer 22 to generate picture 40. The printer creates the picture by depositing pigment on hard copy media. The hard copy media typically comprise paper, but may alternatively comprise substantially any other media known in the art, such as transparency slides and other plastic surfaces. The picture includes not only the image of subject 16, but also the audio data captured in the associated audio file. The audio data are encoded in picture 40 in the form of markings substantially imperceptible to a human viewer of the picture. Methods for creating the composite picture and for performing such marking are described further hereinbelow.

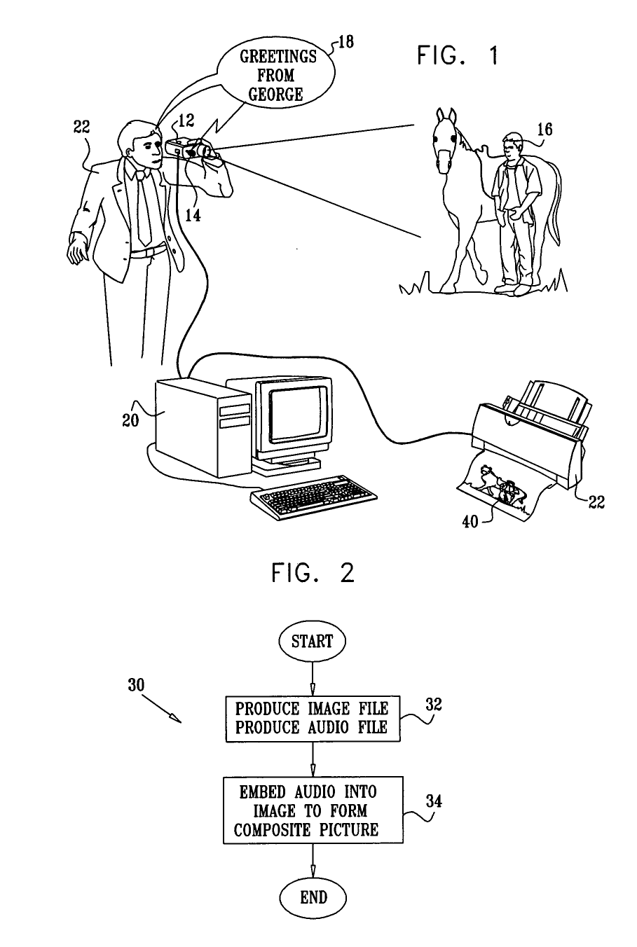

FIG. 2 is a flowchart showing steps of a process 30 used to produce picture 40 with embedded audio data, according to a preferred embodiment of the present invention. A first step 32 comprises producing an initial image file of subject 16, and an associated initial audio file, substantially as described above with reference to FIG. 1. Camera 12 typically generates the image file in a standard format, such as JPEG, GIF, TIFF, or BMP, as are known in the art. Similarly, the audio file, produced either by microphone 14 or by an external source, is typically in a standard format, such as WAV or MP3. Alternatively, other standard or proprietary formats may be used to hold the image and audio data prior to producing picture 40.

In a processing step 34, the data from the audio file is embedded into the initial image file so as to produce composite picture 40. The composite picture may be generated directly by camera 12 in the form of a composite file, such that when the file is used to reproduce the original image of subject 16 as a picture, substantially imperceptible markings are generated in the picture. Alternatively, the composite picture may be generated by computer 20 based on separate image and audio inputs received from camera 12 or from the camera and from a separate audio source. Further alternatively, printer 22 may be configured to receive audio input, as well as image data, and thus may autonomously produce pictures with markings that encode the audio data. In any case, step 34 is typically carried out under the control of program code (software or firmware), running on a suitable processor in camera 12, computer 20 or printer 22. The program code may be loaded into the processor in electronic form, or it may alternatively be provided on tangible media, such as optical or magnetic media or non-volatile solid state memory.

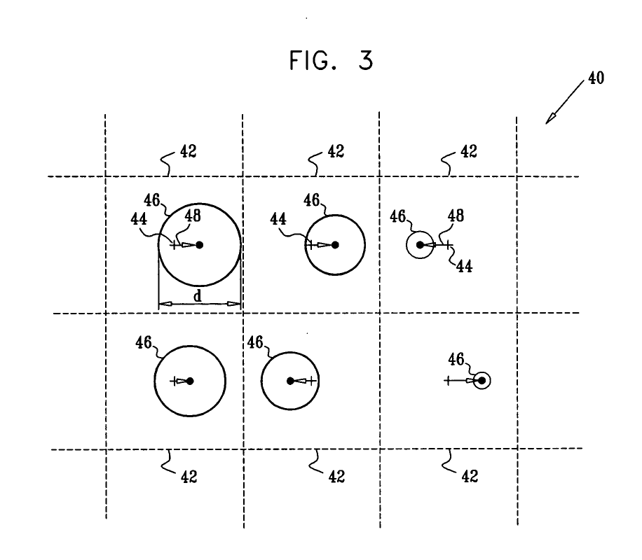

FIG. 3 is a schematic, enlarged view showing a detail of picture 40, in accordance with an embodiment of the present invention. This embodiment uses a halftone image representation to encode audio data. In accordance with this mode of representation, picture 40 is printed as a matrix of cells 42, each corresponding to a pixel in the initial image file. Each cell 42 contains a dot 46, wherein the diameter of the dot, d, is determined by the gray scale value of the corresponding pixel. (In color images, dots of this sort are printed in each of the component colors of the image.) In conventional half-tone images, each dot is centered within its cell. Alternatively, the dot positions within the cells are randomized in order to give the conventional picture a smoother visual appearance.

In the present embodiment, however, each dot 46 is displaced from a center point 44 of its cell 42 by a displacement 48. The displacement of the dot in each cell is used to encode one or more bits of audio data. Thus, for example, in a simple binary scheme, when dot 46 is located at the left side of its cell 42, the cell represents a zero in the audio data, whereas when the dot is at the right side of its cell, it represents a one. Alternatively, a larger constellation of dot positions may be defined, so that each cell represents two or more bits of audio data. The constellation may be either real (as shown in FIG. 3) or complex. The maximum size of the constellation is determined by the resolution of printer 22 and of the scanner that is used to read picture 40, as described hereinbelow. Even at only a single bit per cell, however, picture 40 is still capable of holding a great deal of audio information. Since the dots in a halftone picture are generally only barely visible to the human eye when the picture is viewed without magnification, small shifts in the dot positions will not have a perceptible impact on the image information seen by a human viewer.

Various methods may be used to encode the audio data in the dot positions in picture 40. For example, the audio data may be captured in a standard file format, and the file may be encoded as a bitstream onto cells 42 in picture 40 in raster order. A predefined alignment pattern in the picture may be used to mark the origin of the raster and to record other encoding data such as the cell size and row length. Alternatively, the audio data may be converted to the frequency domain, typically using a fast Fourier transform (FFT), and the dot positions may be used to encode the frequency-domain data. This approach is advantageous in that it is less susceptible to corruption of the audio data due to flaws, noise and degradation of picture 40.

Techniques for frequency-domain encoding of image data are described in detail in the above-mentioned article by Rosen et al., and these techniques may be applied, mutatis mutandis, to encoding audio data in accordance with an embodiment of the present invention. Rosen et al. also describe methods for encrypting the image data, and applications of halftone data encoding in color images. These methods may likewise be adapted for use in the context of the present invention.

Alternatively, other methods of image marking may be used to encode the audio data in picture 40, based on variations in other pixel characteristics in continuous-tone images, and not only halftones. For example, in a color image, the brightness levels of one or more colors may be modulated, since small brightness level differences are difficult or impossible to detect with the naked eye, but may be detected by a scanner. Similarly, for a black and white image, the pixel gray levels may be varied. Alternatively, any other characteristics that enable incorporation into the picture of marks that are substantially imperceptible to the naked eye, but which are detectable by a scanner, may be used.

Audio files may be relatively large, so that in some embodiments of the present invention, the initial audio file produced at step 32 is reduced in size using a suitable modification method known in the art, prior to embedding the audio data in the picture at step 34. For example, the audio file may be transformed and/or filtered to remove certain frequency components; or the file may be compressed. If the audio file comprises speech, the file may be converted to a text file using a speech-to-text converter. Prosody of the speech may be captured and encoded simultaneously. The modified audio file is embedded into the initial image file at step 34.

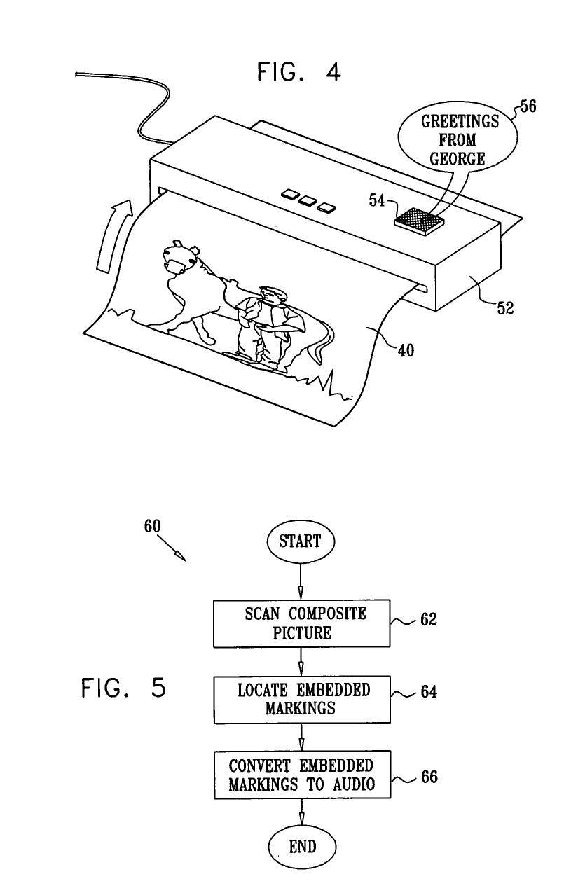

FIG. 4 is a schematic illustration of a scanner 52 for recovering the audio data embedded in picture 40, according to a preferred embodiment of the present invention. The scanner comprises optical reading circuitry, as is known in the art, having sufficient resolution to read the markings encoding the audio data while scanning the picture. The scanner may also comprise a speaker 54, for playing an audio output 56, based on the audio data that is encoded in the picture. Alternatively, a separate speaker may be used. The actual decoding of the audio data, based on the scanned picture, may be carried out either by suitable processing circuitry operating in scanner 52 or under the control of software running on a separate computer (not shown in this figure). The program code for this purpose may be loaded into the scanner or computer in electronic form, or it may alternatively be provided on tangible media, such as optical or magnetic media or non-volatile solid state memory.

FIG. 5 is a flow chart that schematically illustrates a method 60 for recovering and playing back the audio data from picture 40, according to a preferred embodiment of the present invention. Scanner 52 optically scans picture 40, at a scanning step 62. The resolution of the scan must be sufficient to detect the encoded audio data in the picture. For example, in the case of halftone encoding shown in FIG. 3, scanner 52 should be capable of scanning the picture at a resolution of at least several scan pixels per cell 42, in order to accurately determine the position of dot 46 in each cell. Scanner 52 typically scans picture 40 in a raster pattern, and then either processes the resultant scan data internally, or conveys the data to an external computer for extraction of the embedded audio data.

The processing circuitry in scanner 52 or in the external computer processes the scan data in order to locate the embedded markings in picture 40, at a marking detection step 64. Referring again to the example of halftone encoding described above, the processing circuitry measures the location of each dot 46 relative to its respective cell 42 and/or relative to the neighboring dots. It then converts the relative location coordinates into digital data. Alternatively, the processing circuitry may process the gray scale or color intensity in order to extract the embedded audio data from the picture.

The embedded audio data are played back as audio output 56 from speaker 54 (or from a separate speaker), at an audio conversion step 66. A person viewing picture 40 is thus able to hear the associated, embedded audio content at the same time. Any suitable method known in the art for digital audio playback may be used for this purpose. If the audio data were encoded in the frequency domain, as described above, the embedded audio data are converted back to the time domain by inverse FFT before playback. If the audio data were compressed before embedding in picture 40, the data are suitably decompressed before playback. If the audio data comprise speech, and were recorded in the form of text plus prosody, a text-to-speech converter with prosody input may be used to reconstitute the original speech, as is known in the art. As noted above, these processing steps may be carried out either by circuitry within scanner 52 or by a separate computer. The audio data that have been extracted from picture 40 may, alternatively or additionally, be saved in a file, so that the file may be played back subsequently, either by scanner 52 or by another device.

Although the embodiments described above relate to certain particular methods for encoding audio data in a printed image, the principles of the present invention may be applied using other methods for encoding hidden data in images, such as watermarking methods, as are known in the art. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A picture, comprising:
a hard-copy medium; and
pigment, imprinted on the hard-copy medium so as to define an image incorporating markings that are substantially imperceptible to an unaided eye of a human viewer and that encode audio data associated with the image.

2. The picture according to claim 1, wherein the pigment is imprinted on the hard-copy medium so as to define dots of varying sizes within respective cells, and wherein the audio data are encoded in the picture by varying respective positions of the dots within the respective cells.

3. A method for encoding information, comprising:
capturing an image of a subject so as to generate image data;
receiving an audio input associated with the subject so as to generate audio data; and
printing a picture of the subject responsively to the image data, while encoding the audio data using markings in the printed picture that are substantially imperceptible to an unaided eye of a human viewer.

4. The method according to claim 3, wherein capturing the image comprises photographing the image using an electronic imaging camera, and wherein receiving the audio input comprises recording the audio input using a microphone coupled to the camera.

5. The method according to claim 3, wherein printing the picture comprises printing a halftone picture comprising dots of varying sizes within respective cells, and wherein encoding the audio data comprises varying respective positions of the dots within the cells responsively to the audio data.

6. The method according to claim 3, and comprising detecting and decoding the markings in the printed picture, and generating an audio output responsively to the decoded markings.

7. The method according to claim 3, wherein the audio input comprises speech, and wherein receiving the audio input comprises converting the speech to at least one of text and prosody of the speech, and wherein encoding the audio data comprises encoding the at least one of the text and the prosody.

8. A method for recovering information, comprising:
scanning a picture comprising an image and incorporating in the image markings that are substantially imperceptible to an unaided eye of a human viewer and that encode audio data associated with the image;
detecting and decoding the markings in the scanned picture; and
generating an audio output responsively to the decoded markings.

9. Apparatus for encoding information, comprising:
an image capture device, which is arranged to capture an image of a subject so as to generate image data;
a processor, which is coupled to receive audio data associated with the subject, and which is arranged to generate a composite image of the subject comprising the image data, while encoding the audio data in the composite image using markings that are substantially imperceptible to an unaided eye of a human viewer; and
a printer, which is arranged to print a picture of the subject comprising the encoded audio data responsively to the composite image.

10. The apparatus according to claim 9, wherein the image capture device comprises an electronic imaging camera, which further comprises a microphone for capturing the audio data.

11. The apparatus according to claim 9, wherein the picture comprises a halftone picture comprising dots of varying sizes within respective cells, and wherein the processor is arranged to vary respective positions of the dots within the cells so as to encode the audio data.

12. The apparatus according to claim 9, and comprising a scanner, which is arranged to detect the markings in the printed picture, so as to permit an audio output to be generated responsively to the markings.

13. The apparatus according to claim 9, wherein the audio data comprises speech, and comprising a speech-to-text converter that converts the speech to at least one of text and prosody of the speech, and wherein encoding the audio data comprises encoding the at least one of the text and the prosody.

14. Apparatus for recovering information, comprising:
a scanner, which is arranged to scan a picture comprising an image incorporating markings that are substantially imperceptible to an unaided eye of a human viewer and that encode audio data associated with the image;
a processor, which is arranged to detect and decode the markings in the scanned picture so as to recover the audio data from the picture; and
an audio speaker, which is coupled to the processor so as to play the recovered audio data.

15. A computer software product, comprising a computer-readable medium in which program instructions are stored, which instructions, when read by a programmable processor, cause the processor to receive image data representative of an image of a subject, and to receive audio data associated with the subject, and to generate a picture of the subject comprising the image data, while encoding the audio data in the picture using markings that are substantially imperceptible to an unaided eye of a human viewer.

16. The product according to claim 15, wherein the picture comprises a halftone picture comprising dots of varying sizes within respective cells, and wherein the instructions cause the processor to vary respective positions of the dots within the cells so as to encode the audio data.

17. The product according to claim 15, wherein the instructions further cause the processor to detect the markings in the printed picture, so as to recover the audio data from the markings.

18. A computer software product, comprising a computer-readable medium in which program instructions are stored, which instructions, when read by a programmable processor, cause the processor to receive input data from a scanned image of a picture that incorporates markings that are substantially imperceptible to an unaided eye of a human viewer and that encode audio data associated with the image, and to detect and decode the markings in the scanned image so as to recover the audio data from the picture.
